(19) United States
(12) Patent Application Publication
(10) Pub. No.: US 2021/0397780 A1
(43) Pub. Date: Dec. 23, 2021

(54) METHOD, DEVICE, AND STORAGE MEDIUM FOR CORRECTING ERROR IN TEXT

(71) Applicant: BEIJING BAIDU NETCOM SCIENCE AND TECHNOLOGY CO., LTD., Beijing (CN)

(72) Inventors: Chao PANG, Beijing (CN); Shuohuan WANG, Beijing (CN); Yu SUN, Beijing (CN); Zhi LI, Beijing (CN)

(73) Assignee: BEIJING BAIDU NETCOM SCIENCE AND TECHNOLOGY CO., LTD., Beijing (CN)

(21) Appl. No.: 17/405,813

(22) Filed: Aug. 18, 2021

(30) Foreign Application Priority Data
Dec. 22, 2020 (CN) 202011533483.3

(51) Int. Cl. G06F 40/166; G06K 9/46; G06K 9/62; G06N 20/00

(52) U.S. Cl. CPC G06F 40/166; G06N 20/00; G06K 9/6215; G06K 9/46

(57) ABSTRACT

A method for correcting an error in a text, an electronic device, and a storage medium are provided. The method includes: obtaining an original text; obtaining a training text by preprocessing the original text; extracting a plurality of feature vectors corresponding to each word in the training text; obtaining an input vector by processing the plurality of feature vectors; obtaining a target text by inputting the input vector into a text error correction model; and adjusting parameters of the text error correction model based on a difference between the target text and the original text.

### FIELD

The disclosure relates to the field of computer technologies and more particularly to the field of artificial intelligence such as deep learning and natural language processing, and further relates to a method for correcting an error in a text, an electronic device, and a storage medium.

### BACKGROUND

Presently, a goal of spelling error correction is to correct a spelling error in natural language, which is widely used in multiple potential natural language processing applications, such as search optimization, machine translation, and part-of-speech tagging.

### SUMMARY

According to a first aspect of the disclosure, a method for correcting an error in a text is provided. The method includes: obtaining an original text; obtaining a training text by preprocessing the original text; extracting a plurality of feature vectors corresponding to each word in the training text; obtaining an input vector by processing the plurality of feature vectors; obtaining a target text by inputting the input vector into a text error correction model; and adjusting parameters of the text error correction model based on a difference between the target text and the original text.

According to a second aspect of the disclosure, an electronic device is provided. The electronic device includes: at least one processor and a memory. The memory is communicatively coupled to the at least one processor. The memory is configured to store instructions executable by the at least one processor. The at least one processor is caused to implement the method for correcting the error in the text according to the above embodiments of the disclosure when the instructions are executed by the at least one processor.

According to a third aspect of the disclosure, a non-transitory computer readable storage medium having computer instructions stored thereon is provided. The computer instructions are configured to cause a computer to execute the method for correcting the error in the text according to the above embodiments of the disclosure.

It should be understood that, contents described in the Summary are not intended to identify key or important features of embodiments of the disclosure, nor is it intended to limit the scope of the disclosure. Other features of the disclosure will become apparent from the following description.

### BRIEF DESCRIPTION OF THE DRAWINGS

The accompanying drawings are used for better understanding the solution and do not constitute a limitation of the disclosure.

FIG. 1 is a flow chart illustrating a method for correcting an error in a text according to a first embodiment of the disclosure.

FIG. 2 is a flow chart illustrating a method for correcting an error in a text according to a second embodiment of the disclosure.

FIG. 3 is a schematic diagram illustrating extracting a font feature vector according to embodiments of the disclosure.

FIG. 4 is a schematic diagram illustrating extracting a phonetic feature vector according to embodiments of the disclosure.

FIG. 5 is a schematic diagram illustrating a text error correction model according to embodiments of the disclosure.

FIG. 6 is a flow chart illustrating a method for correcting an error in a text according to a third embodiment of the disclosure.

FIG. 7 is a block diagram illustrating an apparatus for correcting an error in a text according to a fourth embodiment of the disclosure.

FIG. 8 is a block diagram illustrating an apparatus for correcting an error in a text according to a fifth embodiment of the disclosure.

FIG. 9 is a block diagram illustrating an electronic device for implementing a method for correcting an error in a text according to embodiments of the disclosure.

### DETAILED DESCRIPTION

Description will be made below to exemplary embodiments of the disclosure with reference to accompanying drawings, which includes various details of embodiments of the disclosure to facilitate understanding and should be regarded as merely examples. Therefore, it should be recognized by the skilled in the art that various changes and modifications may be made to the embodiments described herein without departing from the scope and spirit of the disclosure. Meanwhile, for clarity and conciseness, descriptions for well-known functions and structures are omitted in the following description.

In a practical application, such as search optimization and machine translation, error correction needs to be performed on a text. In the related art, the error correction for the text is realized by performing error recognition firstly, then candidate generation and candidate selection finally. In this way, a one-to-one error type is merely dealt with, but the error correction efficiency and effect are relatively poor.

For the above problem, the disclosure provides a method for correcting an error in a text. The method includes: obtaining an original text; obtaining a training text by preprocessing the original text; extracting multiple feature vectors corresponding to each word in the training text; obtaining an input vector by processing the multiple feature vectors; obtaining a target text by inputting the input vector into a text error correction model; and adjusting parameters of the text error correction model based on a difference between the target text and the original text.

In this way, the original text is preprocessed to generate the training text, and the text error correction model is trained by the training text, such that the text error correction model is enabled to correctly handle different error types while the generation efficiency of the training text is improved.

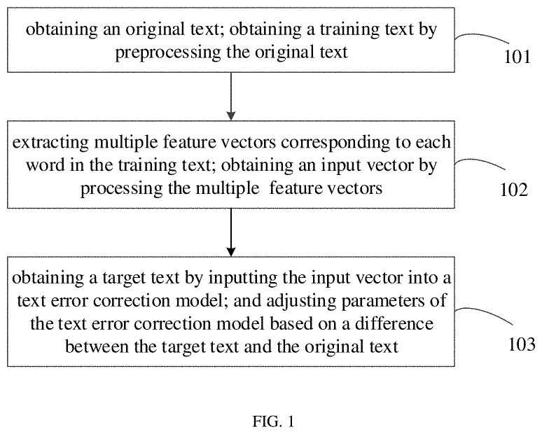

First, FIG. 1 is a flow chart illustrating a method for correcting an error in a text according to a first embodiment of the disclosure. The method for correcting the error in the text is applicable to an electronic device. The electronic device may be any device with computing ability, such as a personal computer (PC), or a mobile terminal. The mobile terminal may be hardware equipment with an operating system, a touch screen and/or a display screen, such as a mobile phone, a tablet, a personal digital assistant, a wearable device and a vehicle-mounted device.

As illustrated in FIG. 1, the method includes the following.

At block 101, an original text is obtained, and a training text is obtained by preprocessing the original text.

In some embodiments of the disclosure, the original text may be understood as a correct text, and may be selected and set based on an application scene, such as “how are you”.

In some embodiments of the disclosure, there are multiple ways for preprocessing the original text, and the way may be selected and set based on an application scene. Examples are as follows.

In a first example, a word order in the original text is adjusted, a word is added to the original text, and one or more words are deleted from the original text.

In a second example, any word in the original text is replaced with a complete spelling of a pinyin corresponding to the word, and any word in the original text is replaced with an abbreviation of the pinyin corresponding to the word.

In a third example, any word in the original text is replaced with a similar word corresponding to the word or a word corresponding to a pinyin similar to the word.

At block 102, multiple feature vectors corresponding to each word in the training text are extracted, and an input vector is obtained by processing the multiple feature vectors.

In some embodiments of the disclosure, the multiple feature vectors corresponding to each word in the training text may be extracted based on a requirement of the application scene. For example, one or more of a font feature vector, a phonetic feature vector, a position feature vector, a semantic vector, and a text vector, corresponding to each word, are extracted.

Examples are as follows.

In a first example, a five-stroke code corresponding to each word is obtained. Respective encoding letter vectors in the five-stroke code are added to obtain a result. The font feature vector is obtained by inputting the result into a full connection network.

In a second example, pinyin letters corresponding to each word are obtained. An initial vector is added to a final vector in the pinyin letters to obtain a result. The phonetic feature vector is obtained by inputting the result into the full connection network.

Further, the multiple feature vectors are processed to obtain the input vector. For example, the font feature vector, the phonetic feature vector, the position feature vector, the semantic vector, and the text vector, corresponding to each word, are added to obtain the input vector.

At block 103, a target text is obtained by inputting the input vector into a text error correction model, and parameters of the text error correction model are adjusted based on a difference between the target text and the original text.

In some embodiments of the disclosure, there are multiple ways for obtaining the target text by inputting the input vector into the text error correction model, and the way may be selected and set based on a requirement of the application scene. Examples are as follows.

In a first example, an encoded vector is obtained by encoding the input vector through an encoder. A semantic vector is obtained by decoding the encoded vector through a decoder. The target text is obtained based on the semantic vector.

In a second example, the input vector is directly processed by a deep neural network to obtain the target text.

Further, the parameters of the text error correction model are adjusted based on the difference between the target text and the original text. In detail, an error value between the target text and the original text is calculated by a loss function, and the parameters of the text error correction model are constantly adjusted based on the error value, thereby ensuring that the error value between the target text and the original text is within a certain range, and improving the error correction ability of the text error correction model.

With the method for correcting the error in the text according to embodiments of the disclosure, the original text is obtained. The training text is obtained by preprocessing the original text. The multiple feature vectors corresponding to each word in the training text are extracted. The input vector is obtained by processing the multiple feature vectors. The target text is obtained by inputting the input vector into the text error correction model. The parameters of the text error correction model are adjusted based on the difference between the target text and the original text. In this way, the original text is preprocessed to generate the training text, and the text error correction model is trained by the training text, such that the text error correction model is enabled to correctly handle different error types while the generation efficiency of the training text is improved.

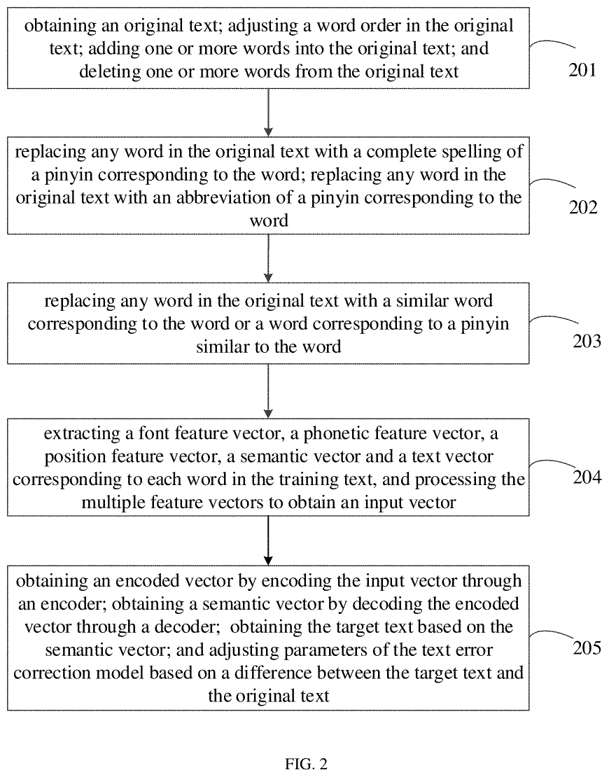

FIG. 2 is a flow chart illustrating a method for correcting an error in a text according to a second embodiment of the disclosure. As illustrated in FIG. 2, the method includes the following.

At block 201, an original text is obtained, a word order in the original text is adjusted, one or more words are added to and deleted from the original text.

In some embodiments of the disclosure, different from that a previous end-to-end error correction model needs the training text annotated manually, there merely needs a large number of unsupervised texts that are easy to obtain, such as reversing the word order, completing words, etc. An error text generated by randomly breaking up the word order in the original text or randomly adding and subtracting a Chinese character is taken as the training text.

At block 202, any word in the original text is replaced with a complete spelling of a pinyin corresponding to the word, and any word in the original text is replaced with an abbreviation of the pinyin corresponding to the word.

In some embodiments of the disclosure, for the complete spelling and the abbreviation of a Chinese Pinyin, some Chinese characters or words in the original text may be randomly replaced with an error text generated by complete spelling or abbreviation corresponding to these Chinese characters or words to obtain the training text.

At block 203, any word in the original text is replaced with a similar word corresponding to the word or a word corresponding to a pinyin similar to the word.

In some embodiments of the disclosure, for a homophonic word, a confusing word, a word-like error, and the like, the training text may be obtained by replacing the words and Chinese characters in the original text with an error text generated by the confusing word or a Chinese character with a similar pronunciation and shape.

In this way, the training text is generated by preprocessing the original text without manual annotation, such that the text error correction model is enabled to correctly handle different error types while the generation efficiency of the training text is improved.

At block 204, a font feature vector, a phonetic feature vector, a position feature vector, a semantic vector and a text vector, corresponding to each word in the training text, are extracted, and the multiple feature vectors are processed to obtain an input vector.

It should be noted that, one of most common mistakes in the error correction for Chinese spelling is to write a correct Chinese character to a Chinese character with a pronunciation or shape similar to the correct Chinese. Therefore, in some embodiments of the disclosure, the five-stroke code corresponding to each word may be obtained. Respective encoded letter vectors in the five-stroke code are added to obtain a result, and then the result is input into the full connection network to obtain a font feature vector. Pinyin letters corresponding to each word are obtained. An initial vector is added to a final vector in the pinyin letters to obtain a result, and the result is input into the full connection network to obtain the phonetic feature vector.

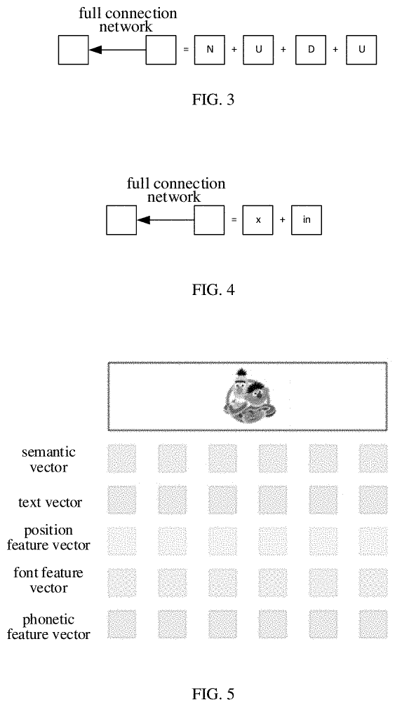

In detail, a five-stroke font is a font code, which may split the Chinese character into roots. Each Chinese character may be expressed as a unique letter code. Chinese characters with similar fonts often have similar coding sequences. Therefore, the five-stroke code is used to calculate font information of the Chinese character. As illustrated in FIG. 3, a five-stroke code of “ [symbol] (Chinese character, which means buy)” is NUDU. First, vectors of respective encoded letters are looked up. Respective encoded letter vectors are summed up to obtain a result. The result is input into the full connection network to obtain the final font feature vector of the Chinese character.

In detail, Chinese Pinyin is the most common phonetic encoding, which includes initials and finals. As illustrated in FIG. 4, the Chinese Pinyin of “ [symbol] (Chinese character, which means new)” is “xin”, where the initial is “x”, and the final is “in”. Vectors of the initial and the final are found in the same word, and the final phonetic feature vector of the Chinese character is obtained by adding the vectors of the initial and the final.

In some embodiments of the disclosure, the vector representation of each element in the font feature vector and the phonetic feature vector and the corresponding parameters of the full connection network may be trained and optimized together with the text error correction model. In this way, the word sounds and glyphs information is added, and the ability of the text error correction model for dealing with an error appearing in words with similar pronunciations and shapes is enhanced. In addition, there is no need to confuse sets in the decoding stage.

Further, multiple feature vectors are processed to obtain the input vector, that is, the font feature vector, the phonetic feature vector, the position feature vector, the semantic vector and the text vector, corresponding to each word, are added to obtain the input vector.

At block 205, the encoded vector is obtained by encoding the input vector through an encoder, the semantic vector is obtained by decoding the encoded vector through a decoder, the target text is obtained based on the semantic vector, and the parameters of the text error correction model are adjusted based on the difference between the target text and the original text.

In some embodiments of the disclosure, an encoder-decoder model structure with a copy mechanism is pre-trained on a large-scale of unsupervised corpora, such that the text error correction model has a strong error correction ability for most error types, and the processed correct vector is directly copied without encoding again, thereby improving the training efficiency.

In detail, as illustrated in FIG. 5, the encoder-decoder model structure with the copy mechanism takes the training text, i.e., the error text, as the input, and takes the correct text as the output, such that the text error correction model has the error correction ability by training a large amount of corpora.

Therefore, the text error correction model may have a strong error correction ability for most error types by pre-training massive unmarked texts. It should be noted that, the text error correction model subjected to the pre-training may be fine-tuned to further improve the effect of the text error correction model when there is manually marked error correction corpus.

With the method for correcting the error in the text according to embodiments of the disclosure, the original text is obtained. The word order in the original text is adjusted. The one or more words are added to and deleted from the original text. Any word in the original text is replaced with the complete spelling of the pinyin corresponding to the word, and any word in the original text is replaced with the abbreviation of the pinyin corresponding to the word. Any word in the original text is replaced with the similar word corresponding to the word or the word corresponding to the pinyin similar to the word. The font feature vector, the phonetic feature vector, the position feature vector, the semantic vector and the text vector, corresponding to each word in the training text, are extracted, and multiple feature vectors are processed to obtain the input vector. The encoded vector is obtained by encoding the input vector through the encoder. The semantic vector is obtained by decoding the encoded vector through the decoder. The target text is obtained based on the semantic vector. The parameters of the text error correction model are adjusted based on the difference between the target text and the original text. In this way, a large amount of unsupervised texts is processed with various noises, without manually marking data, and an end-to-end model is used to process various error types, thereby improving the error correction capability of the text error correction model.

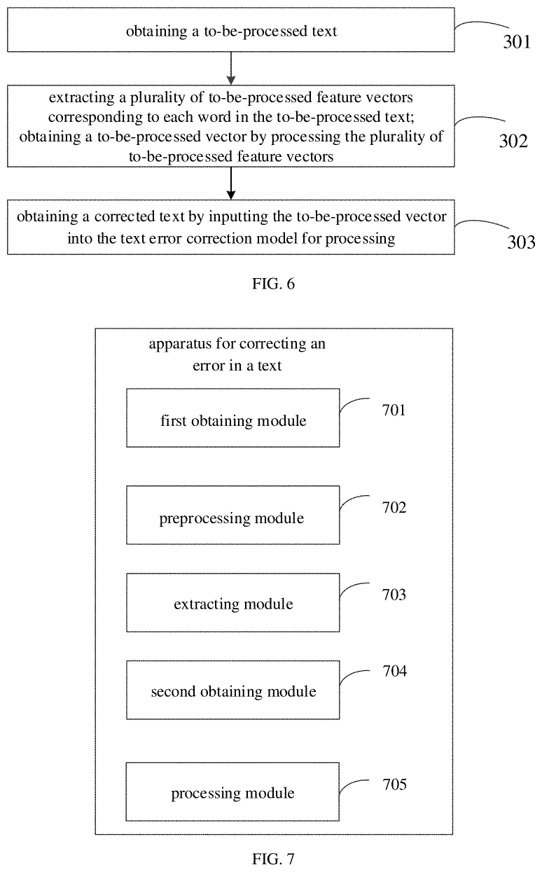

Based on the above embodiments, after the parameters of the text error correction model are adjusted, that is, after the pre-training performed on the text error correction model is completed, error correction processing may be performed for the text. Detailed description will be made below with reference to FIG. 6.

FIG. 6 is a flow chart illustrating a method for correcting an error in a text according to a third embodiment of the disclosure. As illustrated in FIG. 6, after the action at block 103, the method also includes the following.

At block 301, a to-be-processed text is obtained.

At block 302, multiple to-be-processed feature vectors corresponding to each word in the to-be-processed text are extracted, and a to-be-processed vector is obtained by processing the multiple to-be-processed feature vectors.

In some embodiments of the disclosure, the to-be-processed text may be understood as a text to be corrected, and may be selected and set based on an application scene, such as “ [symbol] (Chinese characters, which has the error, and the correct text may be [symbol] to mean hello?)”.

In some embodiments of the disclosure, multiple feature vectors corresponding to each word in the to-be-processed text may be extracted based on a requirement of the application scene, such as one or more of a font feature vector, a phonetic feature vector, a position feature vector, a semantic vector and a text vector, corresponding to each word, are extracted.

Examples are as follows.

In a first example, a five-stroke code corresponding to each word is obtained. Respective encoding letter vectors in the five-stroke code are added to obtain a result. The font feature vector is obtained by inputting the result into a full connection network.

In a second example, pinyin letters corresponding to each word are obtained. An initial vector is added to a final vector in the pinyin letters to obtain a result. The phonetic feature vector is obtained by inputting the result into the full connection network.

Further, the multiple feature vectors are processed to obtain the to-be-processed vector. For example, the font feature vector, the phonetic feature vector, the position feature vector, the semantic vector and the text vector, corresponding to each word, are added to obtain the to-be-processed vector.

At block 303, a corrected text is obtained by inputting the to-be-processed vector into the text error correction model for processing.

In some embodiments of the disclosure, an encoded vector is obtained by encoding the to-be-processed vector through an encoder. A semantic vector is obtained by decoding the encoded vector through a decoder. The corrected text is obtained based on the semantic vector.

With the method for correcting the error in the text according to embodiments of the disclosure, the to-be-processed text is obtained. The multiple to-be-processed feature vectors corresponding to each word in the to-be-processed text are extracted. The to-be-processed vector is obtained by processing the multiple to-be-processed feature vectors. The corrected text is obtained by inputting the to-be-processed vector into the text error correction model for processing. In this way, the text error correction model is employed to correct the error in the text, which improves the efficiency and accuracy of the error correction for the text.

To achieve the above embodiments, the disclosure also provides an apparatus for correcting an error in a text. FIG. 7 is a block diagram illustrating an apparatus for correcting an error in a text according to a fourth embodiment of the disclosure. As illustrated in FIG. 7, the apparatus includes: a first obtaining module 701, a preprocessing module 702, an extracting module 703, a second obtaining module 704, and a processing module 705.

The first obtaining module 701 is configured to obtain an original text.

The preprocessing module 702 is configured to obtain a training text by preprocessing the original text.

The extracting module 703 is configured to extract multiple feature vectors corresponding to each word in the training text.

The second obtaining module 704 is configured to obtain an input vector by processing the multiple feature vectors.

The processing module 705 is configured to obtain a target text by inputting the input vector into a text error correction model, and to adjust parameters of the text error correction model based on a difference between the target text and the original text.

In embodiments of the disclosure, the preprocessing module 702 is configured to perform one or a combination of: adjusting a word order in the original text; adding a word into the original text; deleting one or more words from the original text; replacing any word in the original text with a complete spelling of a pinyin corresponding to the word; replacing any word in the original text with an abbreviation of a pinyin corresponding to the word; and replacing any word in the original text with a similar word corresponding to the word or a word corresponding to a pinyin similar to the word.

In embodiments of the disclosure, the extracting module 703 is configured to: obtain a five-stroke code corresponding to each word; and add respective encoding letter vectors in the five-stroke code to obtain a result, and obtain a font feature vector by inputting the result into a full connection network.

In embodiments of the disclosure, the extracting module 703 is configured to: obtain pinyin letters corresponding to each word; and add an initial vector and a final vector in the pinyin letters to obtain a result, and to obtain a phonetic feature vector by inputting the result into a full connection network.

In embodiments of the disclosure, the processing module 705 is configured to: obtain an encoded vector by encoding the input vector through an encoder; obtain a semantic vector by decoding the encoded vector through a decoder; and obtain the target text based on the semantic vector.

With the apparatus for correcting the error in the text according to embodiments of the disclosure, the original text is obtained. The training text is obtained by preprocessing the original text. The multiple feature vectors corresponding to each word in the training text are extracted. The input vector is obtained by processing the multiple feature vectors. The target text is obtained by inputting the input vector into the text error correction model. The parameters of the text error correction model are adjusted based on the difference between the target text and the original text. In this way, the original text is preprocessed to generate the training text, and the text error correction model is trained by the training text, such that the text error correction model is enabled to correctly handle different error types while the generation efficiency of the training text is improved.

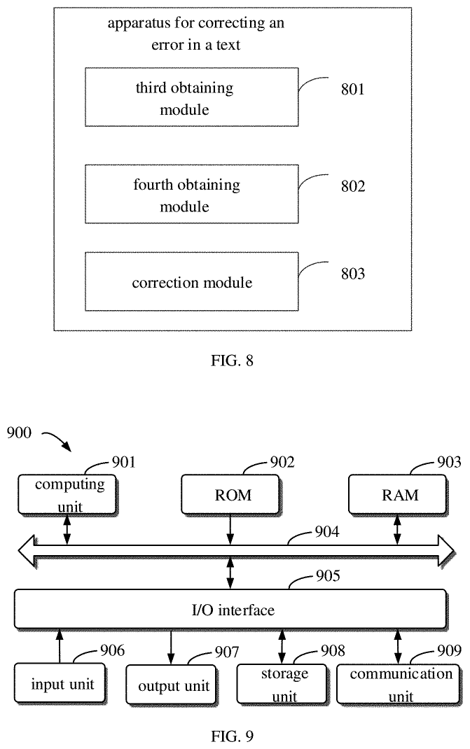

To achieve the above embodiments, the disclosure also provides an apparatus for correcting an error in a text. FIG. 8 is a block diagram illustrating an apparatus for correcting an error in a text according to a fifth embodiment of the disclosure. As illustrated in FIG. 8, the apparatus includes: a third obtaining module 801, a fourth obtaining module 802, and a correction module 803.

The third obtaining module 801 is configured to obtain a to-be-processed text.

The fourth obtaining module 802 is configured to extract multiple to-be-processed feature vectors corresponding to each word in the to-be-processed text, and to obtain a to-be-processed vector by processing the multiple to-be-processed feature vectors.

The correction module 803 is configured to obtain a corrected text by inputting the to-be-processed vector into the text error correction model for processing.

With the apparatus for correcting the error in the text according to embodiments of the disclosure, the to-be-processed text is obtained. The multiple to-be-processed feature vectors corresponding to each word in the to-be-processed text are extracted. The to-be-processed vector is obtained by processing the multiple to-be-processed feature vectors. The corrected text is obtained by inputting the to-be-processed vector into the text error correction model for processing. In this way, the text error correction model is employed to correct the error in the text, which improves the efficiency and accuracy of the error correction for the text.

According to embodiments of the disclosure, the disclosure also provides an electronic device and a readable storage medium.

FIG. 9 is a block diagram illustrating an electronic device 900 for implementing embodiments of the disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device. The components, connections and relationships of the components, and functions of the components illustrated herein are merely examples, and are not intended to limit the implementation of the disclosure described and/or claimed herein.

As illustrated in FIG. 9, the apparatus 900 includes a computing unit 901. The computing unit 901 may perform various appropriate actions and processes based on a computer program stored in a read only memory (ROM) 902 or loaded from a storage unit 908 into a random access memory (RAM) 903. In the RAM 903, various programs and data required for the operation of the device 900 may also be stored. The computing unit 901, the ROM 902, and the RAM 903 are connected to each other via a bus 904. An input/output (I/O) interface 905 is also connected to the bus 904.

Multiple components in the apparatus 900 are connected to the I/O interface 905. The multiple components include an input unit 906, such as a keyboard, and a mouse; an output unit 907, such as various types of displays and speakers; a storage unit 909, such as a magnetic disk, and an optical disk; and a communication unit 909, such as a network card, a modem, and a wireless communication transceiver. The communication unit 909 allows the apparatus 900 to exchange information/data with other devices via a computer network such as the Internet and/or various telecommunication networks.

The computing unit 901 may be various general-purpose and/or special-purpose processing components with processing and computing capabilities. Some examples of the computing unit 901 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 901 performs various methods and processes described above, such as the method for correcting an error in a text. For example, in some embodiments, the method for correcting the error in the text may be implemented as a computer software program tangibly embodied in a machine-readable medium, such as the storage unit 909. In some embodiments, part or all of the computer program may be loaded and/or installed on the apparatus 900 via the ROM 902 and/or the communication unit 909. When the computer program is loaded into the RAM 903 and executed by the computing unit 901, one or more steps of the method for correcting the error in the text described above may be executed. Alternatively, in other embodiments, the computing unit 901 may be configured to perform the method for correcting the error in the text by any other suitable means (for example, by means of firmware).

Various implementations of the systems and techniques described above herein may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), computer hardware, firmware, software, and/or a combination thereof. These various implementations may include being implemented in one or more computer programs. The one or more computer programs may be executed and/or interpreted on a programmable system including at least one programmable processor. The programmable processor may be a special purpose or general purpose programmable processor and receive data and instructions from and transmit data and instructions to a storage system, at least one input device, and at least one output device.

The program codes for implementing the method of the disclosure may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flow charts and/or block diagrams to be implemented. The program codes may be executed completely on the machine, partially on the machine, partially on the machine as an independent software package and partially on a remote machine or completely on a remote machine or server.

In the context of the disclosure, a machine-readable medium may be a tangible medium, which may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, an apparatus, or a device, or any suitable combination of the above. More specific examples of the machine-readable storage medium may include one or more wire-based electrical connections, a portable computer disk, a hard disk, a RAM, a ROM, an erasable programmable read-only memory (EPROM or flash memory), an optical fiber, a portable compact disk read-only memory (CD-ROM), an optical storage device, a magnetic storage device, or any suitable combination of the above.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components and the front-end component. Components of the system may be connected to each other via digital data communication in any form or medium (such as, a communication network). Examples of the communication network include a local area network (LAN), a wide area networks (WAN), and the Internet.

The computer system may include a client and a server. The client and the server are generally remote from each other and generally interact via the communication network. A relationship between the client and the server is generated by computer programs operated on a corresponding computer and having a client-server relationship with each other. The server may be a cloud server, also known as a cloud computing server or a cloud host, which is a host product in a cloud computing service system, to solve difficult management and weak business scalability in conventional physical host and VPS (virtual private server) services.

It should be understood that, steps may be reordered, added or deleted by utilizing flows in the various forms illustrated above. For example, the steps described in the disclosure may be executed in parallel, sequentially or in different orders, so long as desired results of the technical solution disclosed in the disclosure may be achieved, there is no limitation here.

The above detailed implementations do not limit the protection scope of the disclosure. It should be understood by the skilled in the art that various modifications, combinations, sub-combinations and substitutions may be made based on design requirements and other factors. Any modification, equivalent substitution and improvement made within the principle of the disclosure shall be included in the protection scope of disclosure.

What is claimed is:

1. A method for correcting an error in a text, comprising:
obtaining an original text;
obtaining a training text by preprocessing the original text;
extracting a plurality of feature vectors corresponding to each word in the training text;
obtaining an input vector by processing the plurality of feature vectors;
obtaining a target text by inputting the input vector into a text error correction model; and
adjusting parameters of the text error correction model based on a difference between the target text and the original text.

2. The method of claim 1, wherein preprocessing the original text comprises one or a combination of:
adjusting a word order in the original text;
adding a word into the original text;
deleting one or more words from the original text;
replacing any word in the original text with a complete spelling of a pinyin corresponding to the word;
replacing any word in the original text with an abbreviation of a pinyin corresponding to the word; and
replacing any word in the original text with a similar word corresponding to the word or a word corresponding to a pinyin similar to the word.

3. The method of claim 1, wherein extracting the plurality of feature vectors corresponding to each word comprises:
obtaining a five-stroke code corresponding to each word; and
adding respective encoding letter vectors in the five-stroke code to obtain a result, and obtaining a font feature vector by inputting the result into a full connection network.

4. The method of claim 1, wherein extracting the plurality of feature vectors corresponding to each word comprises:
obtaining pinyin letters corresponding to each word; and
adding an initial vector and a final vector in the pinyin letters to obtain a result, and obtaining a phonetic feature vector by inputting the result into a full connection network.

5. The method of claim 1, wherein obtaining the target text by inputting the input vector into the text error correction model comprises:
obtaining an encoded vector by encoding the input vector through an encoder;
obtaining a semantic vector by decoding the encoded vector through a decoder; and
obtaining the target text based on the semantic vector.

6. The method of claim 1, further comprising:
obtaining a to-be-processed text;
extracting a plurality of to-be-processed feature vectors corresponding to each word in the to-be-processed text;
obtaining a to-be-processed vector by processing the plurality of to-be-processed feature vectors; and
obtaining a corrected text by inputting the to-be-processed vector into the text error correction model for processing.

7. An electronic device, comprising:
at least one processor; and
a memory, communicatively coupled to the at least one processor,
wherein the memory is configured to store instructions executable by the at least one processor, and when the instructions are executed by the at least one processor, the at least one processor is caused to perform the operations:
obtaining an original text;
obtaining a training text by preprocessing the original text;
extracting a plurality of feature vectors corresponding to each word in the training text;
obtaining an input vector by processing the plurality of feature vectors;
obtaining a target text by inputting the input vector into a text error correction model; and
adjusting parameters of the text error correction model based on a difference between the target text and the original text.

8. The device of claim 7, wherein preprocessing the original text comprises one or a combination of:
adjusting a word order in the original text;
adding a word into the original text;
deleting one or more words from the original text;
replacing any word in the original text with a complete spelling of a pinyin corresponding to the word;
replacing any word in the original text with an abbreviation of a pinyin corresponding to the word; and
replacing any word in the original text with a similar word corresponding to the word or a word corresponding to a pinyin similar to the word.

9. The device of claim 7, wherein extracting the plurality of feature vectors corresponding to each word comprises:
obtaining a five-stroke code corresponding to each word; and
adding respective encoding letter vectors in the five-stroke code to obtain a result, and obtaining a font feature vector by inputting the result into a full connection network.

10. The device of claim 7, wherein extracting the plurality of feature vectors corresponding to each word comprises:
obtaining pinyin letters corresponding to each word; and
adding an initial vector and a final vector in the pinyin letters to obtain a result, and obtaining a phonetic feature vector by inputting the result into a full connection network.

11. The device of claim 7, wherein obtaining the target text by inputting the input vector into the text error correction model comprises:
obtaining an encoded vector by encoding the input vector through an encoder;
obtaining a semantic vector by decoding the encoded vector through a decoder; and
obtaining the target text based on the semantic vector.

12. The device of claim 7, wherein the operations further comprise:
obtaining a to-be-processed text;
extracting a plurality of to-be-processed feature vectors corresponding to each word in the to-be-processed text;
obtaining a to-be-processed vector by processing the plurality of to-be-processed feature vectors; and
obtaining a corrected text by inputting the to-be-processed vector into the text error correction model for processing.

13. A non-transitory computer readable storage medium having computer instructions stored thereon, wherein the computer instructions are configured to cause a computer to perform the operations:
obtaining an original text;
obtaining a training text by preprocessing the original text;
extracting a plurality of feature vectors corresponding to each word in the training text;
obtaining an input vector by processing the plurality of feature vectors;
obtaining a target text by inputting the input vector into a text error correction model; and
adjusting parameters of the text error correction model based on a difference between the target text and the original text.

14. The non-transitory computer readable storage medium of claim 13, wherein preprocessing the original text comprises one or a combination of:
adjusting a word order in the original text;
adding a word into the original text;
deleting one or more words from the original text;
replacing any word in the original text with a complete spelling of a pinyin corresponding to the word;
replacing any word in the original text with an abbreviation of a pinyin corresponding to the word; and
replacing any word in the original text with a similar word corresponding to the word or a word corresponding to a pinyin similar to the word.

15. The non-transitory computer readable storage medium of claim 13, wherein extracting the plurality of feature vectors corresponding to each word comprises:
obtaining a five-stroke code corresponding to each word; and
adding respective encoding letter vectors in the five-stroke code to obtain a result, and obtaining a font feature vector by inputting the result into a full connection network.

16. The non-transitory computer readable storage medium of claim 13, wherein extracting the plurality of feature vectors corresponding to each word comprises:
obtaining pinyin letters corresponding to each word; and
adding an initial vector and a final vector in the pinyin letters to obtain a result, and obtaining a phonetic feature vector by inputting the result into a full connection network.

17. The non-transitory computer readable storage medium of claim 13, wherein obtaining the target text by inputting the input vector into the text error correction model comprises:
obtaining an encoded vector by encoding the input vector through an encoder;
obtaining a semantic vector by decoding the encoded vector through a decoder; and
obtaining the target text based on the semantic vector.

18. The non-transitory computer readable storage medium of claim 13, wherein the operations further comprise:
obtaining a to-be-processed text;
extracting a plurality of to-be-processed feature vectors corresponding to each word in the to-be-processed text;
obtaining a to-be-processed vector by processing the plurality of to-be-processed feature vectors; and
obtaining a corrected text by inputting the to-be-processed vector into the text error correction model for processing.
